(19) United States
(12) Patent Application Publication
(10) Pub. No.: US 2005/0246493 A1
(43) Pub. Date: Nov. 3, 2005

(54) Detachable programmable memory card for a computer controlled instrument with an indicator on the memory card displaying that a predetermined level of the card memory has been used

(75) Inventor: Anthony Cappa Spielberg, Austin, TX (US)

Correspondence Address: Mark E. McBurney;International Business Machines Corporation, Intellectual Property Law Department, 11400 Burnet Road - Internal Zip 4054, Austin, TX, 78758, US

(73) Assignee: International Business Machines Corporation, Armonk, NY (US)

(21) Appl. No.: 10/835,347

(22) Filed: Apr. 29, 2004

(51) Int. Cl. G06F 12/00

(52) U.S. Cl. 711/115

(57) ABSTRACT

A programmable memory card, operatively insertable into a computer controlled instrument, comprising a memory card housing, a visual indicator on the housing, an electrically erasable programmable read-only memory (EEPROM), an implementation for tracking the portion of said EEPROM being used and apparatus responsive to said tracking implementation for indicating on said indicator that a selected portion level has been used. Both LCDs (Liquid Crystal Displays) and LEDs (Light Emitting Diodes) displays may be used for the indicating means.

### TECHNICAL FIELD

The present invention relates to computer controlled consumer electronics devices or instruments, such as digital cameras, personal digital assistants (PDAs), portable audio and video devices, such as electronic games, as well as handheld computers and wireless telephones.

### BACKGROUND OF RELATED ART

The past decade has been marked by a technological revolution driven by the convergence of the data processing industry with the consumer electronics industry. The effect has, in turn, driven consumer electronics technologies that have been known and available but relatively quiescent over the years to now come into great demand in the marketplace.

The rapid expansion in the capacity of computers to perform support functions, the greater and greater miniaturization of computers, as well as reduction in costs to perform memory and computer operations has opened the door for computer controller consumer instrumentation. A key aspect of this expansion has been lower and lower cost memory. In recent years, this has been manifested in flash memory cards and sticks. At the current technology stage, these memory cards and sticks are detachably inserted into the computer controlled electronic instruments to provide an extra memory capacity of from one half to four to five gigabytes. Memory cards use a flash memory that is based upon EEPROM (electrically erasable programmable read only memory) grid chips. Flash memory EEPROM works much faster than conventional EEPROM. Instead of erasing one byte at a time, it erases an entire block or an entire chip at a time and then rewrites. Smartmedia and Compactflash provide the “electronic film” for digital cameras while the Sony memory stick is quite popular in digital cameras and for computer controlled video games. These high capacity memory card and sticks have been performing hard drive storage function for the above-described computer controlled electronic instruments. In this connection, the SSFDC (solid state floppy disc card) developed by Toshiba Inc. may function as the above-described Smartmedia card. Similarly, the above CompactFlash is a small circuit board with at least one flash memory chip and a dedicated controller chip encased in a housing or shell.

With this rapid expansion of the use of detachable memory cards for an increasing variety of computer controlled electronic instruments, the cards themselves are becoming relatively ubiquitous. The memory cards may be in or on the desks and cabinets of their users. The memories in such cards may be unfilled, partially used or fully used. There is presently no way of efficiently determining from a memory card the extent of usage of the memory capacity of the card. If the memory card is already inserted into the computer controlled receiving instrument, then there may be routines in the computer for the controlled instrument to bring up and display available memory on the inserted card. However, this is generally awkward and requires several steps. However, if the memory cards are stored in the detached state, there is no available way of determining their used memory capacity.

In accordance with an aspect of this invention, the memory card may include a very basic power supply so as to support the indicator whenever the memory card is detached from its computer controlled electronic instrument.

### SUMMARY OF THE PRESENT INVENTION

The present invention provides a solution to the problems related to informing consumers of memory cards of available memory capacity remaining unused in the card at all times, i.e. irrespective of whether the card is dormant or active. Accordingly, the present invention provides a programmable memory card, operatively insertable into a computer controlled instrument, comprising a memory card housing, a visual indicator on the housing, an EEPROM, means for tracking the portion of said EEPROM being used and means responsive to said tracking means for indicating on said indicator means that a selected portion level has been used. Both LCDs (Liquid Crystal Displays) and LEDs (Light Emitting Diode) displays may be used for the indicating means. Very good results are produced when the memory card is a flash memory card and said EEPROM is a flash EEPROM.

The programmable flash memory card preferably also includes controller means for controlling the tracking means and the indicating means.

The indicating means of this invention will operate with the same effectiveness irrespective of whether the memory card is a solid-state floppy disk card, a CompactFlash card comprising a flash memory integrated circuit chip and dedicated controller chip including said controller means enclosed within said housing or any small format memory card.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of a memory card in accordance with the present invention being inserted into a computer controlled electronic instrument, i.e. a digital camera;

FIG. 2 is a diagrammatic illustration of generalized memory card of the present invention simplified to illustrate the memory usage indicators;

FIG. 3 is a block diagram of a simplified control circuitry on controller integrated circuitry on an IC chip on a memory card in accordance with this invention; and

FIG. 4 is an illustrative flowchart in accordance with this invention showing how the memory usage on a memory may be tracked and the level of memory usage indicated.

### DETAILED DESCRIPTION OF THE PREFERRED EMBODIMENT

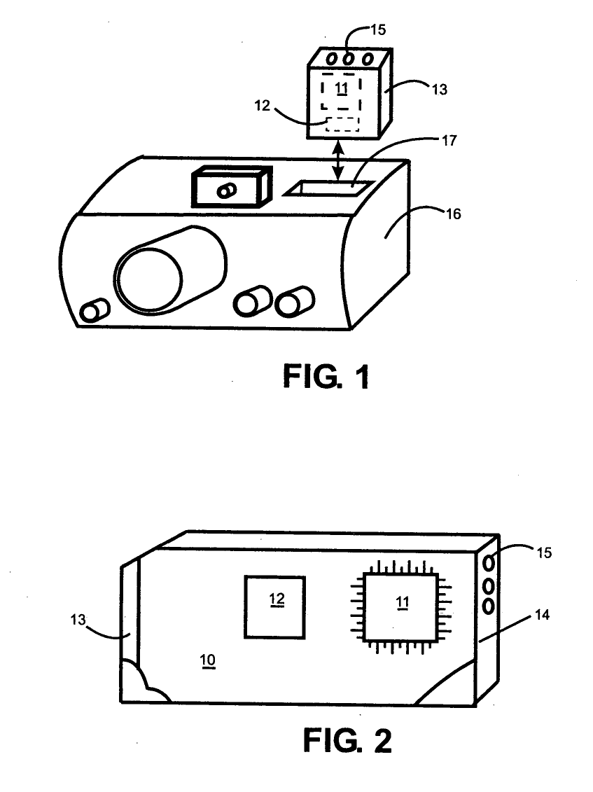

Referring to FIG. 1, a typical use of the memory card of the present invention in connection with a computer controlled instrument, e.g. a digital camera, is shown. The camera 16 has a slot 17 into which memory card 13 may be removably inserted to operatively engage the computer system in the camera to function as a typical extended memory card, as will be hereinafter described in greater detail. Of course, the operations to be described will be applicable to an extended memory card and computer controlled instrument co-action.

Any typical EEPROM flash memory card, such as the memory stick type device being illustrated, comprises, FIG. 2, a housing 10 in which there is mounted and wired the memory array 11 and supporting logic that herein is in the form of an integrated circuit logic chip that functions as a controller 12. An alternative, which is coming into some limited usage as the demand for memory cards increases, is to have the CPU's in the computers in the instruments receiving the cards have already built in interfaces for performing the functions of controller 12. In the simplified illustration of FIG. 2, the memory usage indicators are shown as three lights, e.g. LEDs 15 in an upper wall of housing 10. This indicator may be as simple as a green, yellow and red light, each indicative of a different memory usage state. In other arrangements, simple text messaging may be on a simple one line LCD display positioned in the upper wall 14.

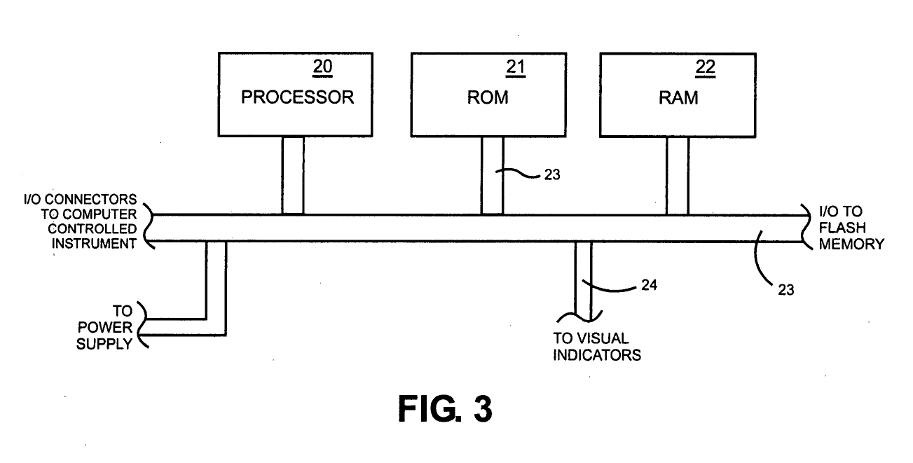

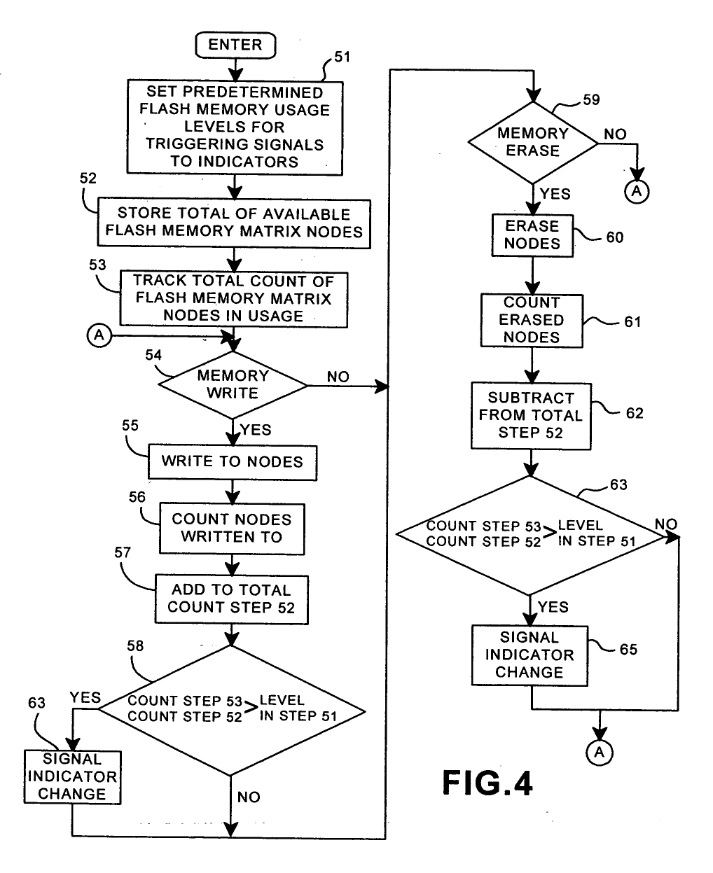

FIG. 3 is a block diagram of simplified control circuitry on controller integrated circuitry on an IC chip 12 on a memory card 13 in accordance with this invention. These controller chips provide specific purpose logic to control the access, reading and writing into the flash memory array chips 11. These logic or control chips contain data processors 20, operating systems stored in RAM 22 (about 2 MB of RAM is provided) and a permanent programmable memory, a programmable ROM that may be an EEPROM, e.g. flash EEPROM. All of the routines and programs may also be conventionally stored in this flash EEPROM 21. These include memory card operating systems and built-in applications that may also be conventionally stored in the RAM. The logic or controller chip 13 also contains a system bus 23 connected via I/O output at one end to the conventional connectors of the memory card to the computer controlled instrument and at the other I/O end to the flash memory EEPROM array IC chip 11. In accordance with the present invention, this relatively standard structure is modified to have an appropriate connection via bus 24 to the visual indicators, such as visual indicators 15, FIG. 2. The indicators are controlled through the controller processor 20 in accordance with the routines illustrated in FIG. 4 to be subsequently described. Since controller processor 20 controls the location of the data stored in the flash EEPROM chip, it already has tracked the extent of usage of the flash memory.

There is also shown a bus branch to a power supply. Where the memory card is functioning already operatively inserted into the computer controlled instrument, the power supply of the instrument itself may be used for this function. On the other hand, it is important to the practice of the present invention that when the flash memory card is not engaged with the computer controlled instrument, the indicators still function as described in this invention. In such a case, a simple capacitive circuit arrangement may be used that will store sufficient electrical power when the memory card is operatively engaged with the computer controlled instrument so that the visual indicators may be powered even when the memory card is not in active use, i.e. on the desktop or drawer. Of course, in a newly manufactured card, this capacitive power may be initially stored by an initial charge.

Referring now to FIG. 4, an illustrative flowchart in accordance with this invention showing how the memory usage on a memory card may be tracked and the level of memory usage indicated, predetermined flash memory usage levels are set for triggering appropriate signals to the indicators, step 51. For best results, these levels will be set by the memory card manufacturers to produce indicator signals at appropriate memory usage levels. The present invention is not dependent on any particular indicator apparatus; any conventional visual indicator apparatus that produces a text or other visual signal corresponding to the triggering memory level may effectively be used. The total count of available flash memory matrix nodes is stored, step 52. The total count of memory matrix nodes in current usage is tracked, step 53. Next, a determination is made as to whether there is a write to the memory on the flash memory card, step 54. If Yes, the appropriate nodes are written to, step 55, and the nodes written to are counted, step 56. Step 57, the total count from step 56 is added to the count in step 53. A determination is then calculated, step 58, as to whether the count in step 53 divided by the count in step 52 exceeds a memory usage set in step 51. If Yes, there is a signal indicator. Next, or if the decision from step 54 is No, a determination is made as to whether there is a memory erase, step 59. If Yes, the appropriate nodes are to be erased, step 60, the erased nodes are counted, step 61. The count of subtracted nodes is subtracted from the count in step 52. A determination is then calculated, step 64, as to whether the count in step 53 divided by the count in step 52 falls below a memory usage set in step 51. If Yes, there is a signal indicator, step 65. Next, or if the decision from step 64 or from step 59 is No, the flow is returned via branch “A” to step 54.

Although certain preferred embodiments have been shown and described, it will be understood that many changes and modifications may be made therein without departing from the scope and intent of the appended claims.

1. A programmable memory card, operatively insertable into a computer controlled instrument, comprising:
a memory card housing;
a visual indicator on said housing;
an electrically erasable programmable read-only memory;
means for tracking the portion of said memory being used; and
means responsive to said tracking means for indicating on said indicator means that a selected portion level has been used.

2. The programmable memory card of claim 1 wherein said visual indicator is an LCD (Liquid Crystal Display).

3. The programmable memory card of claim 1 wherein said visual indicator comprises an LED (Light Emitting diode) display.

4. The programmable memory card of claim 1 wherein said memory card is a flash memory card and said memory is a flash EEPROM.

5. The programmable flash memory card of claim 4 further including controller means for controlling said means for tracking and said means for indicating.

6. The programmable flash memory card of claim 5 wherein said flash memory card is a CompactFlash card comprising a flash memory integrated circuit chip and dedicated controller chip including said controller means enclosed within said housing.

7. The programmable flash memory card of claim 5 wherein said flash memory card is a memory stick.

8. The programmable flash memory card of claim 5 further including a power supply for maintaining said visual indicator means.

9. A computer controlled instrument having a detachable programmable memory card operatively inserted therein, said memory card comprising:
a memory card housing;
a visual indicator on said housing;
an electrically erasable programmable read-only memory (EEPROM);
means for tracking the portion of said (EEPROM) being used; and
means responsive to said tracking means for indicating on said indicator means that a selected portion level has been used.

10. The computer controlled instrument with inserted programmable memory card of claim 9 wherein said visual indicator is an LCD (Liquid Crystal Display).

11. The computer controlled instrument with inserted programmable memory card of claim 9 wherein said visual indicator comprises an LED (Light Emitting diode) display.

12. The computer controlled instrument with inserted programmable memory card of claim 9 wherein said memory card is a flash memory card, and said EEPROM is a flash EEPROM.

13. The computer controlled instrument with inserted programmable flash memory card of claim 12 wherein said memory card further includes controller means for controlling said means for tracking and said means for indicating.

14. The computer controlled instrument with inserted programmable flash memory card of claim 12 wherein said flash memory card is a CompactFlash card comprising a flash memory integrated circuit chip and dedicated controller chip including said controller means enclosed within said housing.

15. The computer controlled instrument with inserted programmable flash memory card of claim 12 wherein said flash memory card is a memory stick.

16. The computer controlled instrument with inserted programmable flash memory card of claim 12 wherein said memory card is inserted into a USB I/O slot in said computer controlled instrument.

17. The computer controlled instrument with inserted programmable flash memory card of claim 12 wherein said means for tracking and said means for indicating are controlled by the computer controlled instrument.

18. The computer controlled instrument with inserted programmable flash memory card of claim 12 wherein said computer controlled instrument is a digital camera.

19. The computer controlled instrument with inserted programmable flash memory card of claim 12 wherein said computer controlled instrument is a palm-type computer device.
